(19) United States
(12) Patent Application Publication
(10) Pub. No.: US 2017/0072876 A1
(43) Pub. Date: Mar. 16, 2017

(54) Hardware-Accelerated Protocol Conversion in an Automotive Gateway Controller

(71) Applicant: Broadcom Corporation, Irvine, CA (US)

(72) Inventors: Rajesh Padinzhara Rajan, Bangalore (IN); Abhijit Kumar Choudhury, Cupertino, CA (US); Kabi Prakash Padhi, Fullerton, CA (US); Anuj Rawat, Irvine, CA (US); Dmitrii Loukianov, Chandler, AZ (US)

(21) Appl. No.: 14/923,996

(22) Filed: Oct. 27, 2015

Related U.S. Application Data
(60) Provisional application No. 62/218,218, filed on Sep. 14, 2015.

(51) Int. Cl. B60R 16/023; H04L 29/08; G06F 13/42

(52) U.S. Cl. CPC B60R 16/023; G06F 13/4282; H04L 67/12

(57) ABSTRACT

A network gateway in a vehicle connects heterogeneous networks and buses within the vehicle. The gateway implements hardware acceleration to accomplish protocol translation, e.g., between CAN, LIN, Flexray, and Ethernet buses and networks. In particular, the gateway provides hardware accelerated packet filtering, header lookup, and packet aggregation features.

### PRIORITY CLAIM

This application claims priority to provisional application Ser. No. 62/218,218, filed Sep. 14, 2015, which is entirely incorporated by reference.

### TECHNICAL FIELD

This disclosure relates to automotive communication networks.

### BACKGROUND

Rapid advances in electronics and communication technologies, driven by immense customer demand, have resulted in the widespread adoption of electronic devices in almost every environment. As one example, automobiles and other vehicles now include heterogeneous communication networks dedicated to different electronic ecosystems within the vehicle. The communication networks connect electronic devices ranging from discrete sensors to entire entertainment systems. Improvements in the automotive communication networks will drive further adoption and integration of vehicle electronics.

### BRIEF DESCRIPTION OF THE DRAWINGS

FIG. 1 shows an example of vehicle electronics connected by multiple networks.

FIG. 2 is an example implementation of an in-vehicle network gateway.

FIG. 3 shows a logical flow diagram of processing logic that an in-vehicle network gateway may implement.

FIG. 4 is a second example implementation of an in-vehicle network gateway.

FIG. 5 shows an additional logical flow diagram of processing logic that an in-vehicle network gateway may implement.

FIG. 6 is an example implementation of an in-vehicle network gateway with hardware acceleration bypass.

FIG. 7 shows an additional logical flow diagram of processing logic that an in-vehicle network gateway may implement.

FIG. 8 shows another example of an in-vehicle network gateway.

FIGS. 9-12 show processing flow for use case scenarios for an in-vehicle network gateway.

### DETAILED DESCRIPTION

The in-vehicle network gateway described below provides hardware accelerated intercommunication between heterogeneous in-vehicle networks, in any given direction from one bus or network to another, the reverse direction, and more generally from any source in-vehicle bus or network to any destination in-vehicle bus or network. The gateway provides protocol conversion via message translation, message routing between networks, and error management in real time. The hardware acceleration dramatically reduces inter-protocol conversion latency, which allows the wide range of vehicle electronics control units to communicate with each other with less delay, thereby improving real-time behavior.

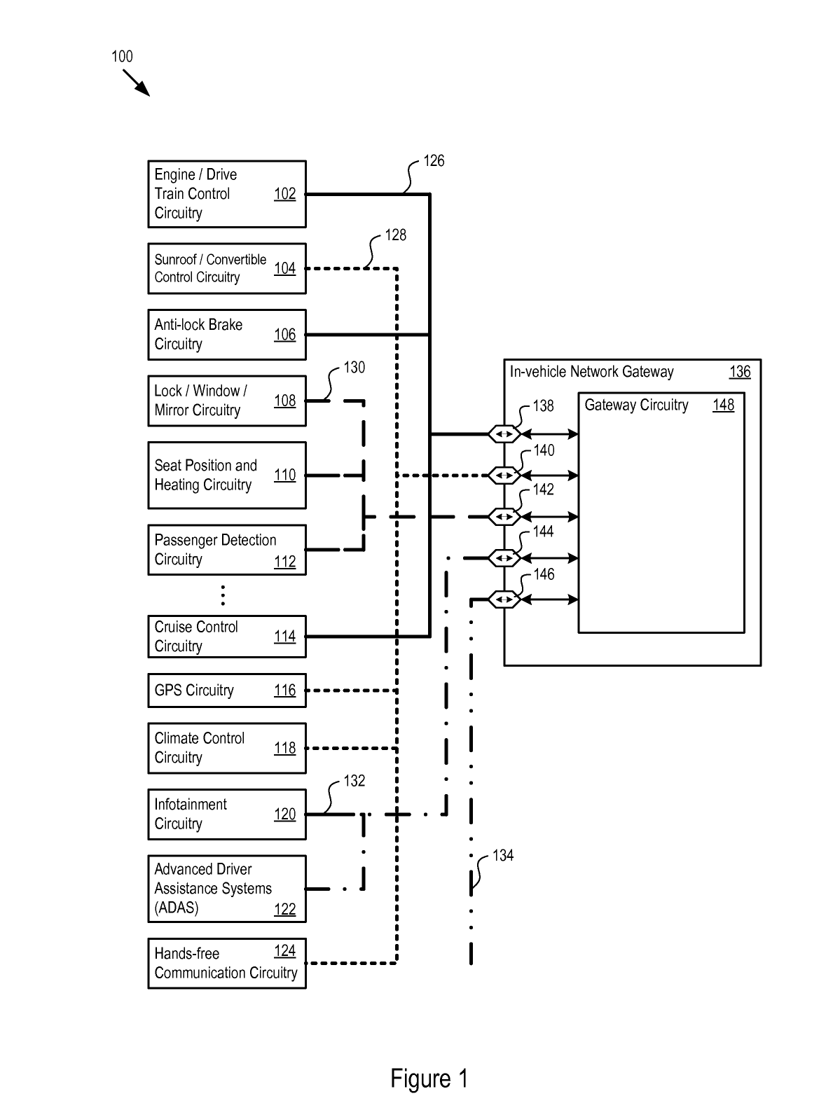

In FIG. 1, a vehicle electronics system 100 includes circuitry or sub-systems that implement many different types of electronic control units (ECUs). The ECUs are responsible for a wide range of functions, and are often optional in the sense that some vehicle packages will include a particular ECU (e.g., sunroof control circuitry), while others will not. The ECUs are not limited to the types described below. Instead, the vehicle may incorporate any type of ECU or distribution of ECUs to provide any desired functionality in the vehicle.

By way of example, the ECUs shown in FIG. 1 include an engine/drive train ECU 102 that monitors and adjusts vehicle engine operation; a sunroof/convertible control ECU 104 that may control opening and closing of a convertible top or sunroof; and an anti-lock brake ECU 106 that controls the brakes in the vehicle to prevent lockups. Other ECUs include the lock/window/mirror ECU 108, the seat position and heating ECU 110, and the passenger detection ECU 112. Further examples include the cruise control ECU 114, the GPS ECU 116, and the climate control ECU 118 that may control heating, cooling, and other environmental aspects of the vehicle. Still further examples of ECUs include the infotainment control ECU 120 (e.g., including stereo system channel selection and audio playback circuitry), the advanced driver assistance systems (ADAS) ECU 122, and the hands-free communication ECU 124.

Any or all of the ECUs may be interconnected over an in-vehicle network or bus. Alternatively, any of the ECUs may be stand-alone, e.g., not connected to other ECUs over an in-vehicle network or bus. There may be multiple different types of physical networks or buses following multiple different types of protocols. Further complicating the architecture is that any number of ECUs may be connected to any number of the various different networks or buses, and these ECUs may need to exchange information. That is, ECUs on different, protocol-incompatible networks or buses may need to exchange information.

The in-vehicle networks and buses may be use any protocol, including an on-board diagnostic system (OBD) bus, an Emissions/Diagnostics bus, Mobile Media bus, or X-by-Wire bus. Other examples of in-vehicle network buses include a Controller Area Network (CAN) bus, serial bus, FlexRay bus, Ethernet bus, Local Interconnect Network (LIN) bus, or Media Oriented Systems Transport (MOST). FIG. 1 shows just one example in which five different in-vehicle buses and networks with five different protocol types are present: the type A bus 126, the type B bus 128, the type C bus 130, the type D bus 132, and the type E bus 134. As just one example, type A may be CAN, type B may be LIN, type C may be FlexRay, and type D may be Ethernet.

An in-vehicle network gateway 136 provides hardware accelerated protocol translation and intercommunication between the different in-vehicle networks. The in-vehicle network gateway 136 includes a type A network or bus interface 138, a type B network or bus interface 140, a type C network or bus interface 142, a type D network or bus interface 144, and a type E network or bus interface 146. Gateway circuitry 148, described in detail below, implements message filtering, message routing, protocol translation acceleration in hardware, message aggregation, and other features that facilitate ECU intercommunication across heterogeneous in-vehicle networks and buses.

The network and bus interfaces 138-146 include the interface circuitry for unidirectional or bidirectional communications over the corresponding in-vehicle network or bus. Any of the ECUs may receive and transmit messages including commands, data, or both over the in-vehicle networks to any other of the ECUs. The messages may include, for instance, a message header and payload.

Any of the network or bus interfaces 138-146 may include a physical “wired” medium (e.g., Ethernet cable or optical cable) transceiver, or a wireless transceiver. That is, the network or bus interfaces 138-146 may then transmit and receive messages without a wired connection. Any of the network or bus interfaces 138-146 may employ any wireless communication protocol such as Bluetooth, 802.11 b/g/n, WiGig, or other wireless communication standards.

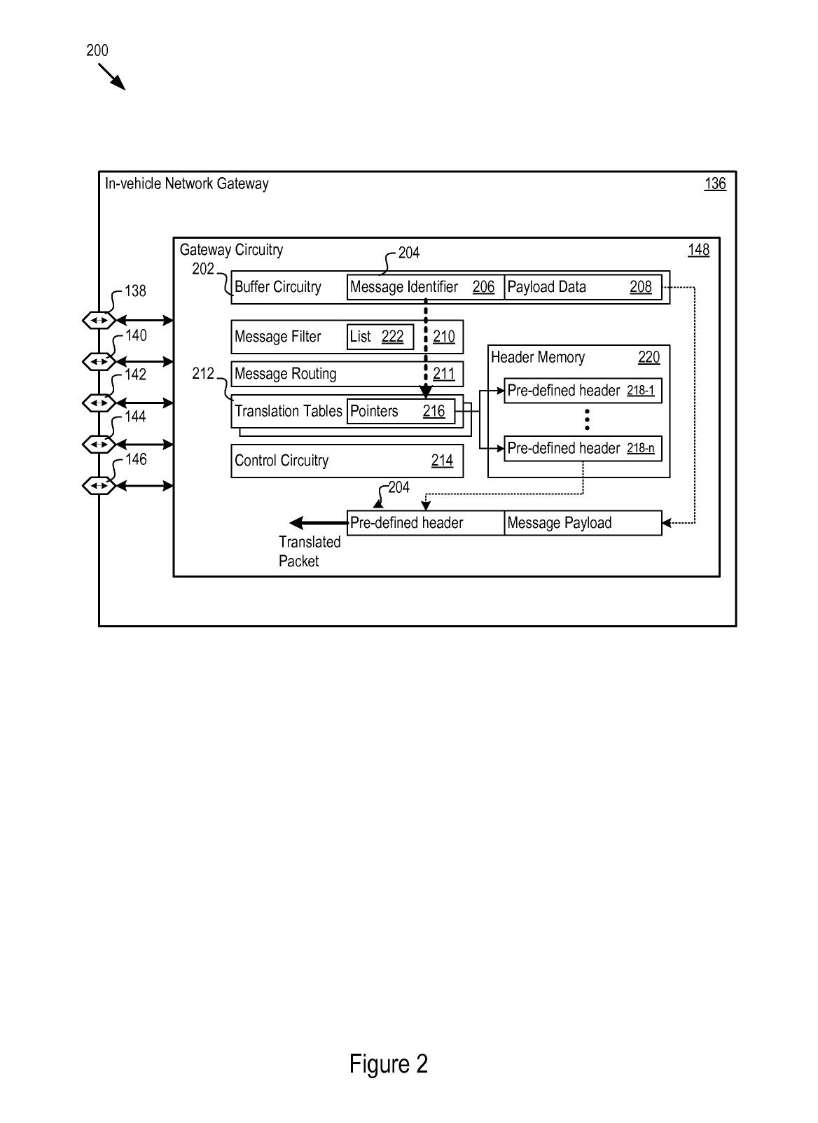

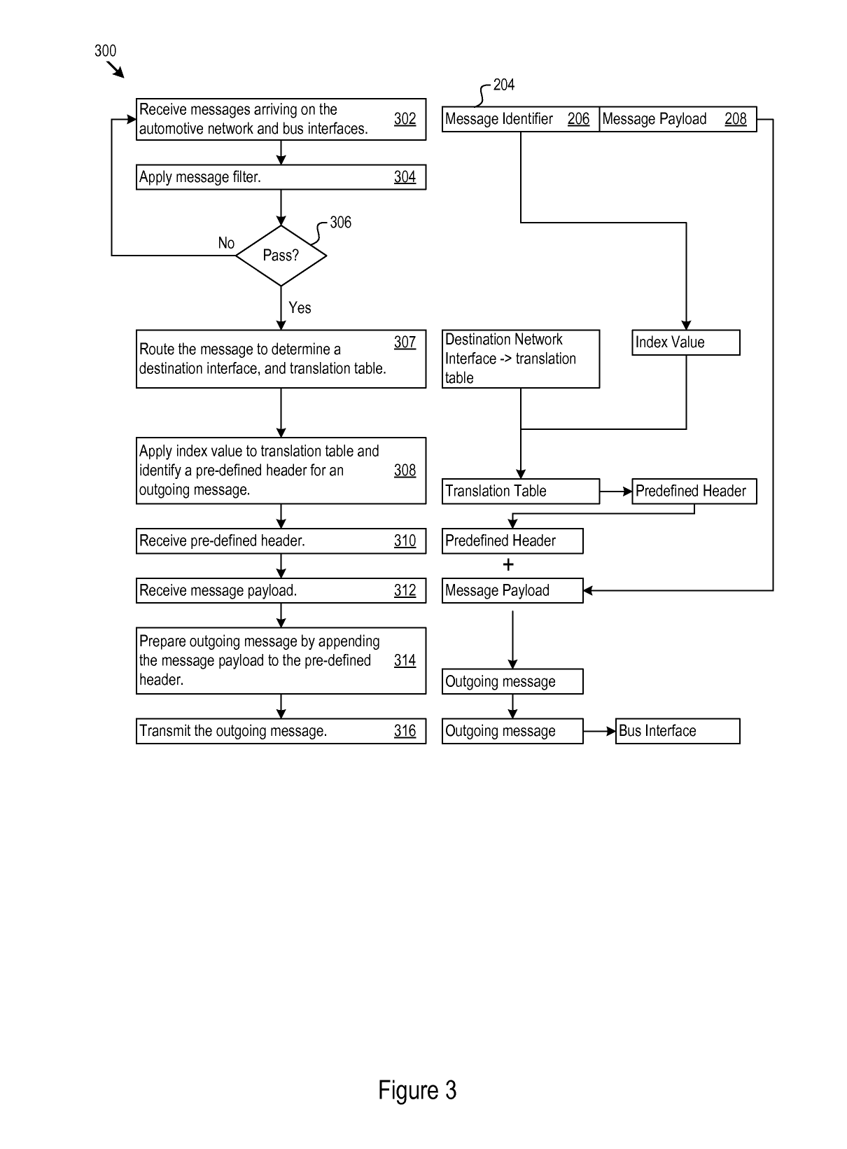

FIG. 2 is a first example implementation 200 of the in-vehicle network gateway 136 and the gateway circuitry 148. FIG. 2 is described in connection with the logical flow diagram of FIG. 3, which shows the processing logic 300 that the in-vehicle network gateway 136 may implement.

In the in-vehicle network gateway 136, there are multiple different automotive network or bus interfaces 138-146. The network and bus interfaces may be of any type, including a protocol A automotive network or bus interface (e.g., a CAN bus interface) and a protocol B automotive network or bus interface (e.g., an Ethernet interface). The in-vehicle network gateway 136 includes one or more instances of buffer circuitry 202 for receiving messages 204 in the form, e.g., of data packets or CAN bus messages, arriving on the automotive network or bus interfaces (302). For example, there may be an instance of buffer circuitry for each different network or bus interface 138-146, e.g., for the CAN bus, defined within a CAN bus transceiver in the gateway circuitry 148.

The messages 204 may vary widely in format per protocol specification, and typically include a message header and a message payload. The message header may include, e.g., a message identifier 206, and the message payload carries the payload data 208. For instance, a CAN bus message may include an 11-bit message identifier or a 29-bit message identifier and payload data including up to 8 bytes of data and other fields, e.g., CRC, ACK, and EOF fields. A LIN message may include a 6-bit message identifier and up to 8 bytes of data and one byte checksum as a message payload. A FlexRay message may include an 11-bit message identifier and up to 254 bytes of payload with a three byte trailer segment as a message payload. An Ethernet message may include a media access control (MAC) header, Internet Protocol (IP) header, a Transmission Control Protocol (TCP) header, and a 42 to 1500 byte payload.

In some cases, the in-vehicle networks and buses communicate large volumes of messages; not all of the messages are destined for the gateway 136. Accordingly, the gateway circuitry 148 may implement a message filter 210. The message filter 210 drops or passes messages for further processing, e.g., to the routing table 211, translation table 212 and the control circuitry 214 (304). The message filter 210 passes the message for further processing when the message meets a filtering criterion (306). For instance, the message filter 210 may pass the message on for further processing when the message identifier is present in a pre-defined list 222 of message identifiers to process, e.g. a white-list. The filtering criteria may be implemented in many different ways, as another example as a time, date, recipient, destination, message type (e.g., ignore or drop error messages) or other criteria, or as a list of message to not process, e.g., a black-list, where all messages not on the list are passed on for further processing.

As an implementation option, when a message identifier does not match an entry in the white list, the message may be send up a software stack for processing. The software stack may include additional logic to decide whether the message should be dropped, or whether the message identifier should be added to the white list, e.g., when pre-determined criterion are met. That is, the message filter 210 may change dynamically to adapt the ongoing processing of the in-network gateway 136.

Additionally, the gateway 136 may implement, either in hardware or in a software stack, a mechanism for removing or replacing entries in the message filter 210. The removal or replacement process may be an aging-based process, for instance. That is, entries in the message filter 210 that exceed a pre-determined threshold age (whether expressed as a measure of time or number of messages processed) without being used may be deleted or marked for replacement. This mechanism may help clear up space in the message filter 210 for other entries, e.g., those dynamically added by the software stack as noted above.

The gateway circuitry 148 may further include a routing table 211 to decide on which network and interface the destination ECU resides on, and hence to which destination network interface the gateway circuitry 148 should forward the message to (307). After the routing table 211 decides the target network, the translation table 212 provides the header, as described below. The translation table 212 facilitates hardware acceleration of protocol conversion. The translation table 212 may provide a hardware lookup to map the received message to a pre-defined portion (e.g., pre-defined headers) of an outgoing message (308). The translation table 212 may store pointers 216 to any number of pre-defined headers 218-1 through 218-n, stored in a header memory 220. As one example, the gateway circuitry 148 may apply the translation table 212 when performing hardware assisted protocol translation of a message received on a first network or bus type (e.g., the CAN bus) that the control circuitry 214 decides to send as an outgoing message on a second network or bus type (e.g., the Ethernet network). Note that there may be multiple translation tables 212 defined in the gateway 136. The translation tables may be prepared in advance for any particular destination network interfaces. For instance, a translation table may be prepared in advance to provide Ethernet network headers for hardware accelerated translation of incoming messages (e.g., from a CAN bus) that are destined for an Ethernet network interface.

The translation table 212 extends over a pre-defined address space and is responsive to an index input. At each address in the address space, the translation table 212 may store a pointer (not necessarily unique) to a pre-defined header in the header memory 220. In other implementations, the translation table 212 stores the pre-defined headers, rather than pointers to the pre-defined headers.

In one particular implementation, the address space is 11-bits wide, or 2048 entries. The address space may thereby correspond to the entire space of possible 11-bit message identifiers for CAN messages and FlexRay messages, for example. This address space also covers the 6-bit space of LIN message identifiers. That is, the message identifier may be the index input, and for each possible message identifier, there may be a pointer in the translation table 212 that points to a pre-defined message header in the header memory 220. As such, the gateway circuitry 148 implements an extremely fast lookup (e.g., in hardware or firmware) for translating messages from one network or bus type to another. The pre-defined message headers may be prepared for any particular type of network or bus interface. When the pre-defined message headers are Ethernet headers, the pre-defined message headers may include any pre-defined set of header data, including one or more of Ethernet header data (e.g., source MAC address and destination MAC address), IP header data (e.g., source and destination address), and TCP or UDP header data (e.g., source and destination port).

FIG. 2 shows that control circuitry 214 is also present. The control circuitry 214 may be implemented entirely in hardware, or as a processor that executes software or firmware instructions to perform the gateway processing. The control circuitry 214 is configured to receive the pre-defined header (310) determined by the translation table 212 and the routing table 211 which determines the destination interface. The control circuitry 214 also receives the remainder of the message data other than the header, e.g., the message payload or packet payload (312). The control circuitry 214 prepares an outgoing message by, e.g., appending the message payload to the pre-defined header (314). The control circuitry 214 also transmits the outgoing message through the automotive network or bus interface corresponding to the outgoing message type, e.g., through an Ethernet port (316).

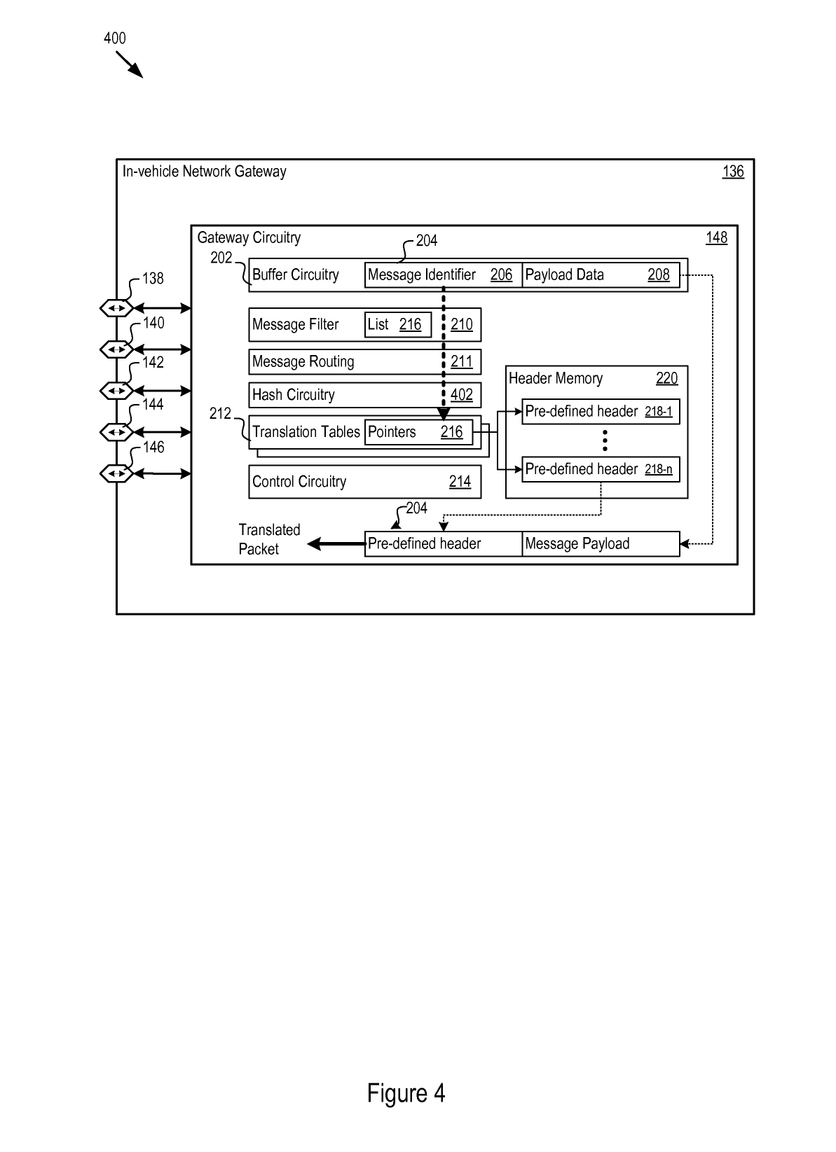

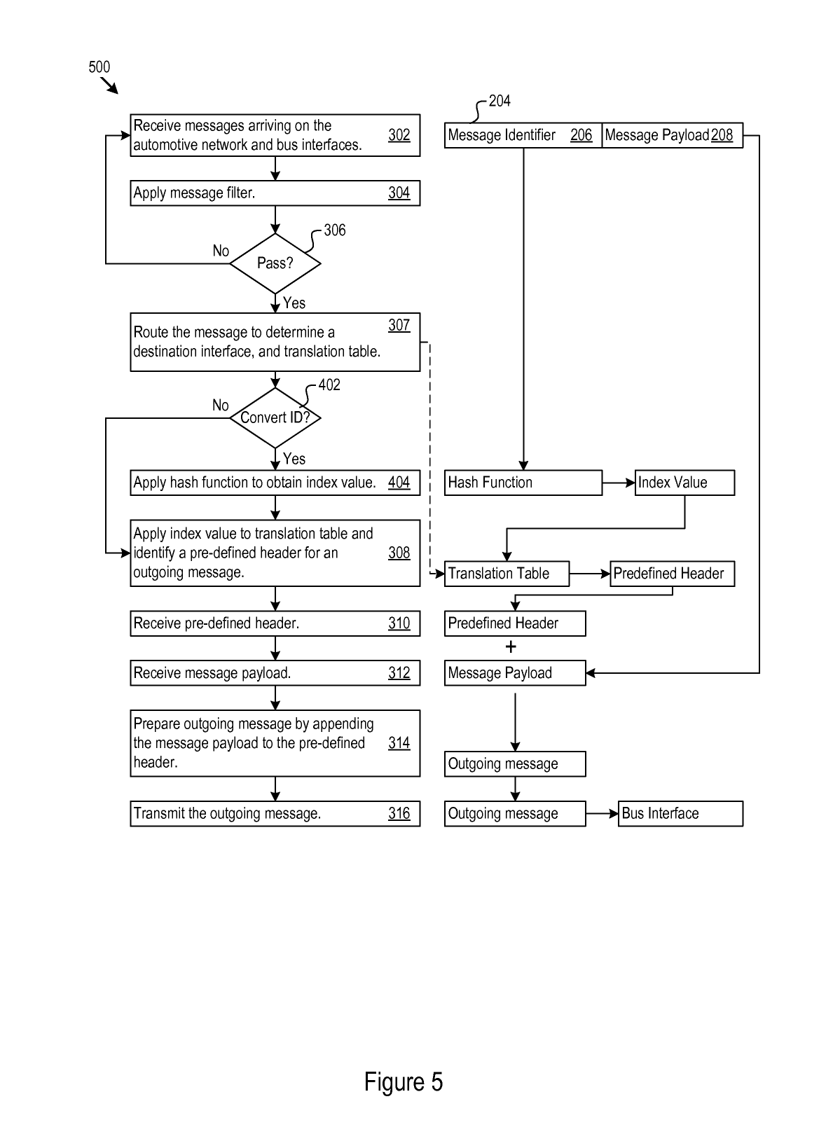

In some implementations, as shown in the example 400 in FIG. 4 and logical flow 500 in FIG. 5, the gateway circuitry 148 also includes hash circuitry 402 configured to determine whether to convert the message identifier into a shorter index value into the translation table 212 (402). The conversion may occur when, for instance, the message identifier length makes direct addressing into the translation table 212 impractical due to the required table size. In that case, the hash circuitry 402 may map the message identifier to the smaller address space of the translation table 212 (404). For instance, the hash circuitry 402 may implement a hash function that maps a 29-bit CAN message identifier to an 11-bit index value for the translation table 212. The hash function may vary widely; as one example the hash function may be a generator polynomial based hash.

Other implementations may be enhanced by having the control circuitry 214 perform message aggregation. Aggregation may be employed when, for instance, network B has substantially higher throughput than network A, and/or the message overhead on the network B is substantially greater than the message payload. One example of such an instance are CAN bus messages flowing to the Ethernet network. For aggregation, the control circuitry 214 may be configured to aggregate the message payloads with additional subsequently received message payloads into a single outgoing message (e.g., a single Ethernet packet). Multiple message payloads associated with a given specific protocol (e.g., the CAN bus protocol) may be destined for a common recipient, e.g., as reflected by having a common pre-defined header determined from the individual message identifiers as received. The control circuitry 214 may aggregate these message payloads into a common outgoing message. The control circuitry 214 may perform aggregation, until a transmission criterion or criteria are satisfied. One example criterion is that the outgoing message reaches maximum length. Another example criterion is that a pre-defined maximum buffer latency has reached a threshold limit, and delaying messages for further aggregation will have adverse effect on the real-time system performance. The gateway may then implement an aggregation timer. The control circuitry 214 may start the aggregation timer when the first message payload is added to the outgoing message and continue aggregation until the maximum time is reached. Yet another example criterion is that a message payload with greater than a pre-defined threshold level of priority is received, and this may preempt low priority message aggregation.

Expressed another way, the in-vehicle network gateway 136 receives a message on a protocol A network or bus interface. The message includes a message identifier and a payload. The in-vehicle network gateway 136 performs message routing to determine if the gateway 136 needs to perform a translation of the message for transmission through a protocol B network or bus interface, where protocol A and protocol B are different automotive network communication protocols. The gateway 136 also determines whether or not to apply hardware acceleration to the translation.

When applying hardware acceleration, the in-vehicle network gateway 136 may perform a lookup in a translation table based on the message identifier to identify a pre-defined protocol B header for that message identifier. The in-vehicle network gateway 136 receives the pre-defined protocol B header, receives the message payload, and prepares a protocol B message including the pre-defined protocol B header and the message payload. The in-vehicle network gateway 136 transmits the protocol B message (e.g., an Ethernet packet) through the protocol B network or bus interface.

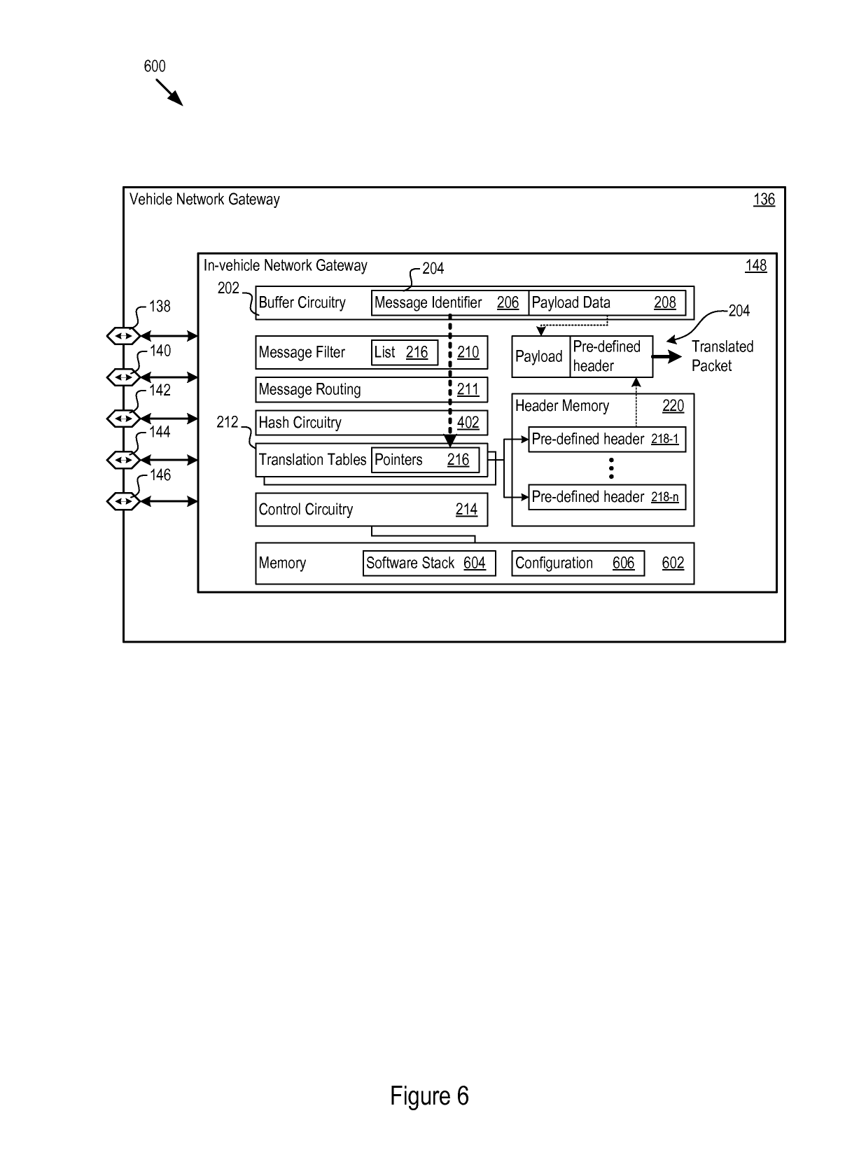

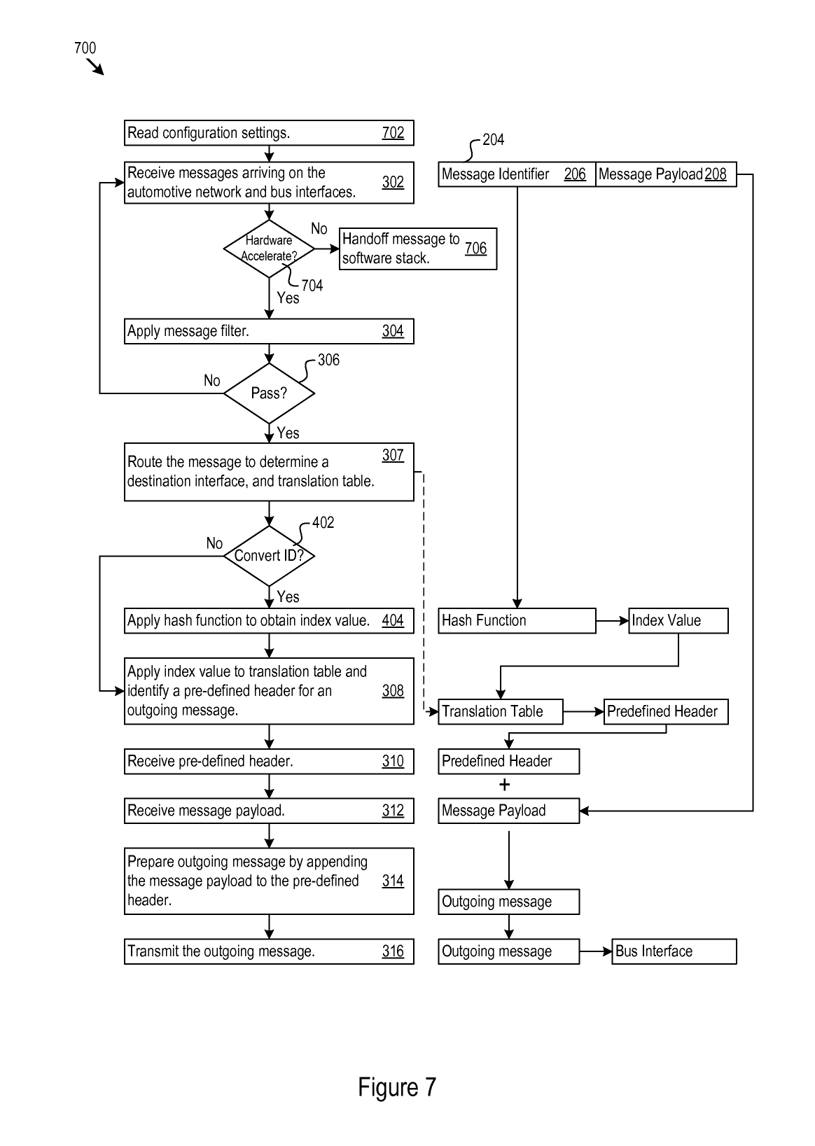

Hardware acceleration is optional, and may be enabled or disabled according to a global configuration parameter, or enabled or disabled on a message-by-message basis, e.g., in configuration settings stored in memory (see below). FIG. 6 shows an example 600, in connection with the logical flow 700 in FIG. 7, of an in-vehicle network gateway 136 that implements a bypass mode of hardware acceleration. In FIG. 6, the control circuitry 214 is coupled to a memory system 602. The memory system 602 stores a software protocol stack 604 and configuration settings 606 for the in-vehicle network gateway 136.

The configuration settings 606 may be set by any authorized system operator. The configuration settings 606 may include an acceleration setting that indicates whether the in-vehicle network gateway 136 will execute hardware acceleration for protocol translation, including message filtering, pre-defined header lookup, and message aggregation. These three acceleration aspects may be enabled or disabled separately within the configuration settings 606.

The control circuitry 214 reads the configuration settings 606 (702). When the configuration settings 606 specify that hardware acceleration will not be applied (704), the control circuitry 214 may submit each received message to the software protocol stack 604 for processing (706). Otherwise, the gateway circuitry 148 may execute any of the hardware acceleration aspects described above. In some implementations, the message filter 210 may apply regardless of whether the configuration settings 606 indicate to use hardware acceleration. The software protocol stack 604 may be implemented as an automotive open system architecture (AutoSAR) compliant software stack, e.g., implementing AUTOSAR release 4.2.

A specific example shows the protocol conversion between a CAN message and an Ethernet message. The gateway circuitry 148 defines multiple different automotive network or bus interfaces, including a CAN automotive bus interface and an Ethernet protocol automotive network interface. Buffer circuitry coupled to the CAN automotive bus interface receives messages on the CAN automotive bus interface. The messages include an 11-bit or 29-bit message identifier and a message payload.

The message filter 210 determines which of the messages to pass for hardware accelerated protocol translation and which to discard or ignore. In this example, the message routing table 211 has determined that the target interface is the Ethernet interface. The translation table 212 defined for the Ethernet interface has an index input that receives a table index value and for each value of the index input, stores a pointer to a pre-defined Ethernet header.

The control circuitry 214 receives a particular message passed by the message filter. After routing the message, the control circuitry 214 also obtains a particular Ethernet header for the particular message through the translation table and generates an Ethernet packet comprising the particular Ethernet header and the data payload of the particular message. The control circuitry 214 transmits the Ethernet packet through the Ethernet protocol automotive network interface.

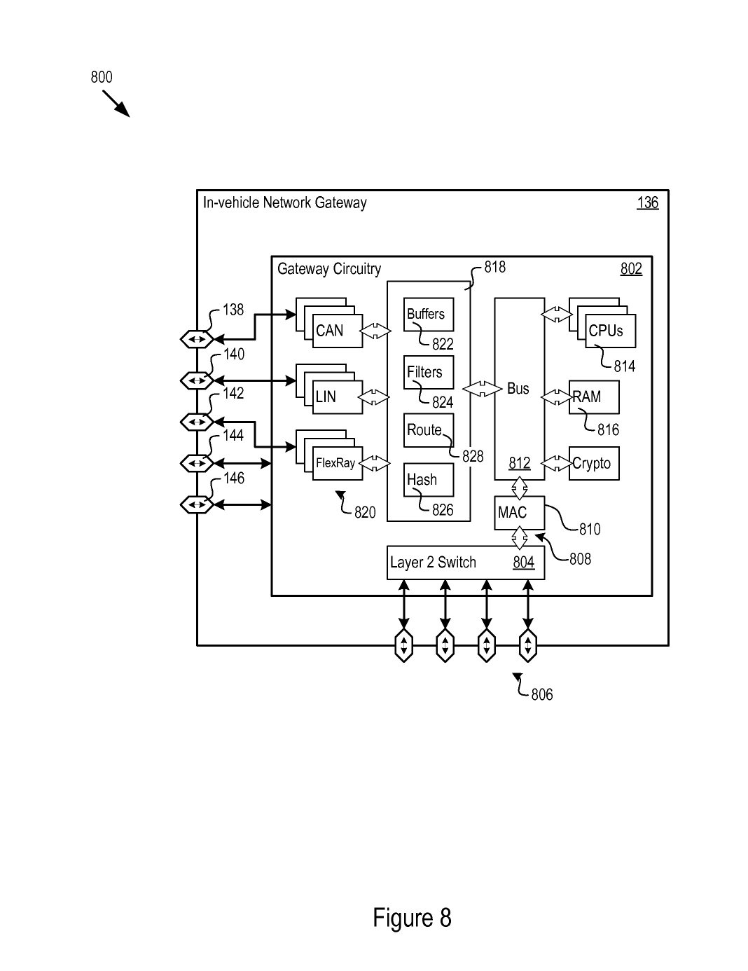

FIG. 8 shows another example implementation of an in-vehicle network gateway 136. In this example, the gateway circuitry 802 includes an Ethernet switch 804 with ports 806 and 808. The Ethernet switch 804 connects through Media Access Control circuitry (MAC) 810 to a system bus 812. The system bus 812 provides a communication mechanism that interconnects the CPUs (or CPU cores) 814, the RAM 816, and the hardware acceleration circuitry 818. The MAC 810 performs bus conversion from the system bus 812 to the format of the Ethernet port interface at the Ethernet switch 804.

As just one example, the CPUs 814 may implement all or part of the control circuitry 214 discussed above, while the RAM 816 (alone or in combination with other memory types) may implement the memory system and store the routing table 211, translation table 212, pre-defined headers 218-1-218-n, the software protocol stack 604, and provide general purpose memory storage for the in-vehicle network gateway 136. The hardware acceleration circuitry 818 may include, e.g., buffers 822 for storing messages, message filters 824, the hash circuitry 826, and the routing tables 828 for determining the destination interface (e.g., as an alternative implementation to routing tables stored in the RAM 816).

FIG. 8 also shows multiple instances of bus transceiver circuitry 820. In this example, the bus transceiver circuitry 820 includes CAN bus transceivers, LIN bus transceivers, and FlexRay bus transceivers. Each instance of transceiver circuitry may include buffer circuitry for storing messages or there could be a single large buffer for all the CAN/LIN/FlexRay messages to avoid the latency in transferring messages from one buffer to another.

The in-vehicle network gateway 136 handles both intra-protocol switching and inter-protocol switching, e.g., CAN-to-CAN traffic as well as CAN-to-Ethernet traffic. The in-vehicle network gateway 136 also handles speed mismatches between interfaces, e.g., traffic from Ethernet to CAN. In that regard, as will be described in more detail below, the in-vehicle network gateway 136 may use the packet buffers in the Ethernet switch 804 to store packets from the Ethernet interface and then shape the traffic out to the CAN (or other) interface. In some implementations, the in-vehicle network gateway 136 may provide priority handling of messages, e.g., prioritize high priority messages over low priority message. In this respect, the in-vehicle network gateway 136 may treat non-Ethernet interfaces as logical ports, and add different queues per non-Ethernet interface assigned to low and high priority traffic.

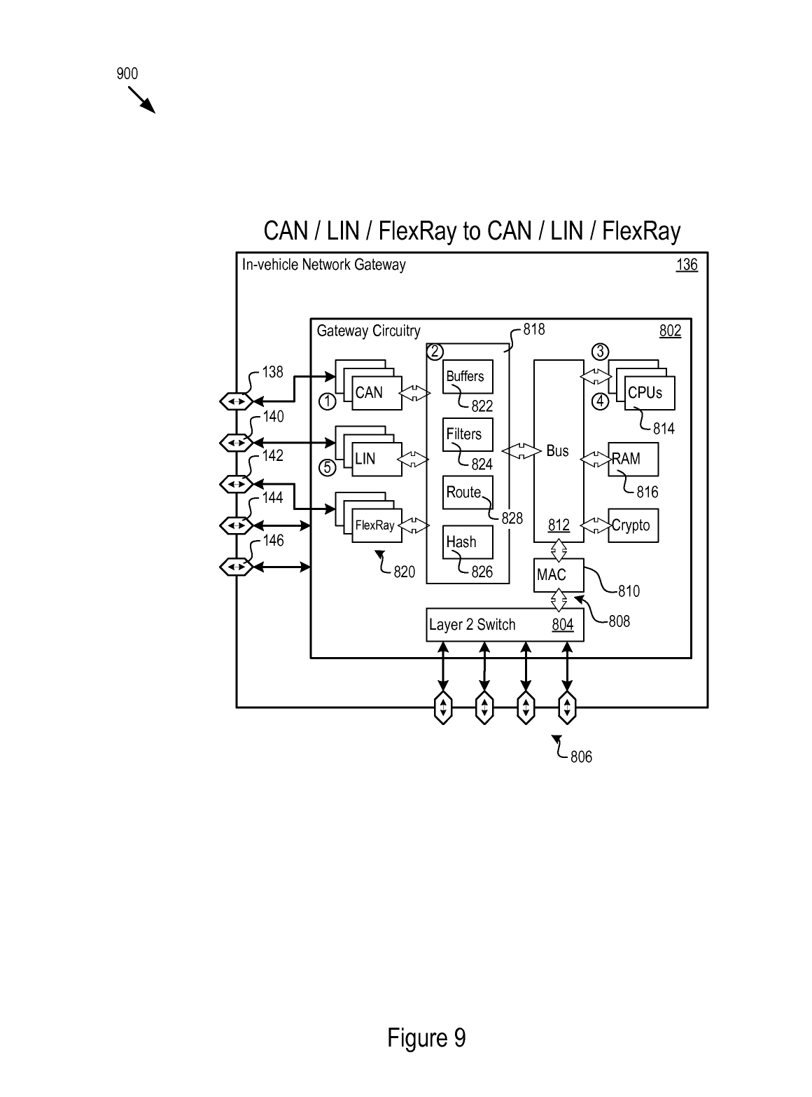

FIGS. 9-12 show processing flow for use case scenarios for an in-vehicle network gateway. FIG. 9 shows a use case 900 for CAN/LIN/FlexRay to CAN/LIN/FlexRay message flow. At (1), a CAN message arrives at the CAN controller and is stored in the buffer 822. The CAN controller may also store a reception timestamp for the CAN message in the buffer 822. The CPU may enforce message ordering in response to the reception timestamps. At (2) the message filters 824 apply to pass messages of interest for further processing. Here, the hash circuitry 826 determines an index value for the translation table, e.g., to covert a 29-bit message identifier to an 11-bit identifier. The index value is not used in this example, however, the hash circuitry 826 may still compute the index value so that it is ready and available in scenarios where messages are flowing to the Ethernet network.

When the message is fully received, then at (3) the CPU reads the message and processes it. For instance, the CPU may execute the software protocol stack 604 to perform initial processing on the message to obtain the message identifier. At (4), the CPU uses the message identifier to perform a routing function and determine whether the message destination is another CAN bus, a LIN bus, a FlexRay bus, Ethernet network, or any combination of networks and buses. In the use case 900, it is assumed that the message will be sent out on a LIN bus. The CPU sends the message down the software protocol stack 604, which delivers the message at (5) to the corresponding LIN controller for transmission.

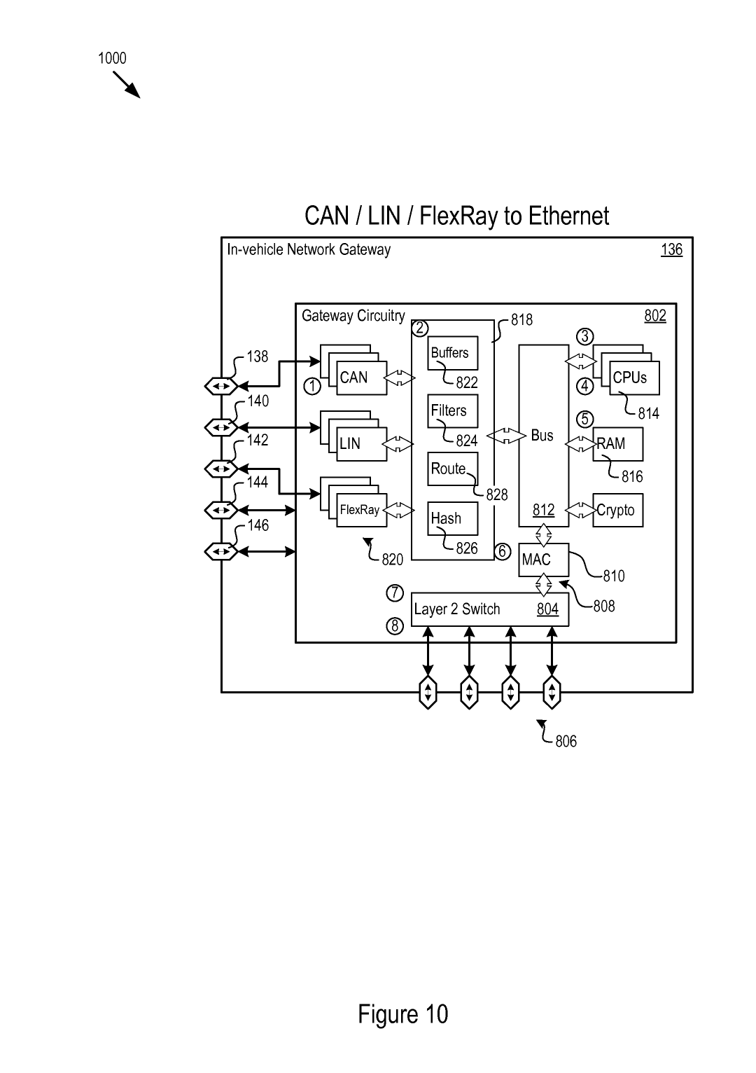

FIG. 10 shows a use case 1000 for CAN/LIN/FlexRay to Ethernet message flow. At (1), a CAN message arrives at the CAN controller and is stored in the buffer 822. At (2) the message filters 824 apply to pass messages of interest to the CPU for further processing. The hash circuitry 826 determines an index value for the translation table, e.g., to covert a 29-bit message identifier to an 11-bit index value. If the length of the received message identifier is already compatible with the translation table address space (e.g., 11-bits), the hash circuitry 826 need not execute.

At (3), the CPU reads the message. At (4), the CPU uses the message identifier to perform a routing function and determine that the message destination in this example is an Ethernet port. In such cases, at (5) the index value (e.g., the 11-bit hash or received message identifier) is applied to the translation table (e.g., in the RAM 816) to look up the corresponding pre-configured Ethernet header. The pre-configured Ethernet header may include encapsulation, e.g., under IEEE 1722a for automotive related data streams.

At (6) the retrieved pre-configured header is pre-pended to the message payload and the resulting outgoing message is sent to the Ethernet switch 804 via the MAC 810. Note that if aggregation is enabled, the aggregation may result in multiple incoming message payloads placed into a single outgoing Ethernet packet. At (7), the outgoing message is queued as an Ethernet frame in the appropriate queue at the egress port (or ports). The queue may be selected responsive to class of service information present in the outgoing message (and specified, e.g., in the pre-configured header) and detected by processing circuitry in the ingress pipeline of the Ethernet switch 804. At (8), the outgoing message the Ethernet switch 804 schedules and transmits the outgoing message out of the destination port (or ports). Note that in the to-Ethernet direction, the Ethernet data rate (e.g., 100 Mbps) is typically much faster than the incoming data rate from CAN, LIN, or FlexRay (e.g., 1 Kbps to 10 Mbps). As a result, the Ethernet switch 804 can readily handle the incoming data flow.

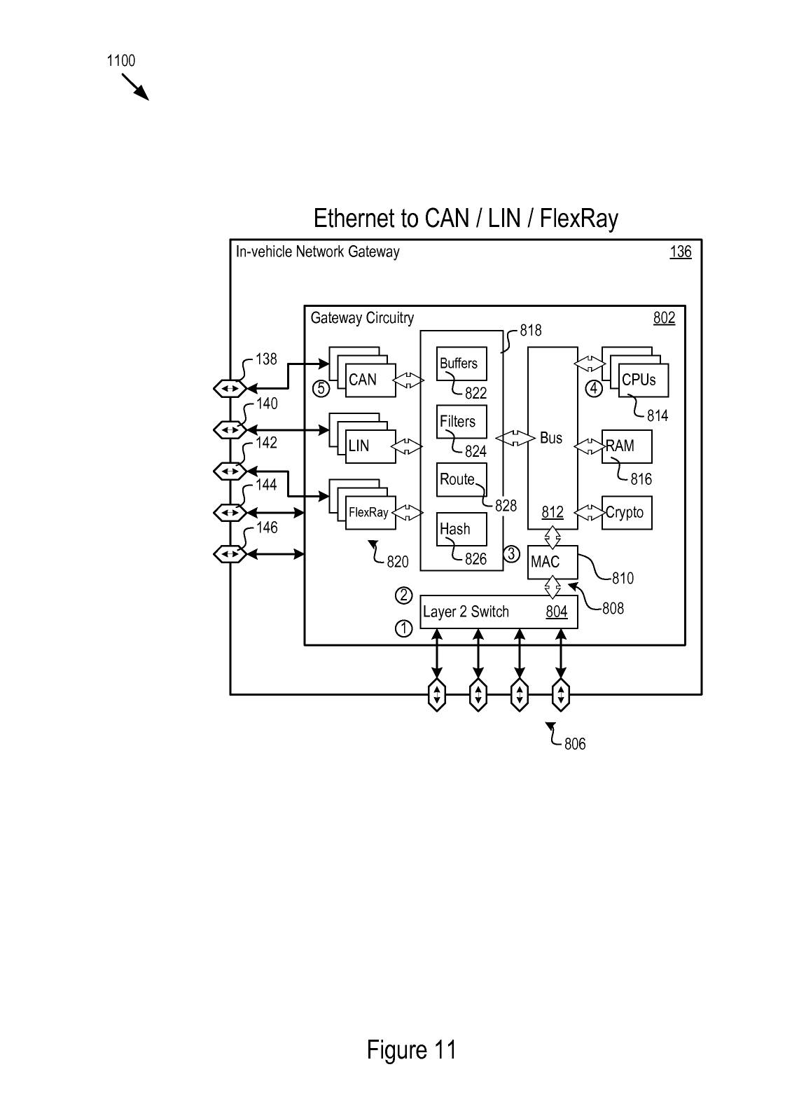

FIG. 11 shows a use case 1100 for Ethernet to CAN/LIN/FlexRay message flow. At (1), an Ethernet frame arrives at the Ethernet switch 804. The Ethernet frame will specify, as the destination, an address assigned to the CPU 814. At (2), the Ethernet switch 804 queues the Ethernet frame on the CPU port at the specified class of service.

Note that in the from-Ethernet direction, the incoming data rate is much faster than the outgoing data rate. For this reason, the gateway circuitry 802 shapes the switch queues to match the rate of the target network or bus interface. At (3), the MAC 810 receives the Ethernet frame, and the CPU 814 reads and processes the Ethernet frame. Note that the incoming Ethernet frame may include IEEE 1722a encapsulation that specifies a message identifier and other automotive data flow information. At (4), the CPU 814 reads the encapsulation information and performs a routing function and determines the destination, e.g., the CAN bus for the message identifier. At (5), the CPU passes the Ethernet frame down the software protocol stack 604, which converts the Ethernet frame to a CAN message protocol format, and sends the CAN message to the CAN controller for transmission.

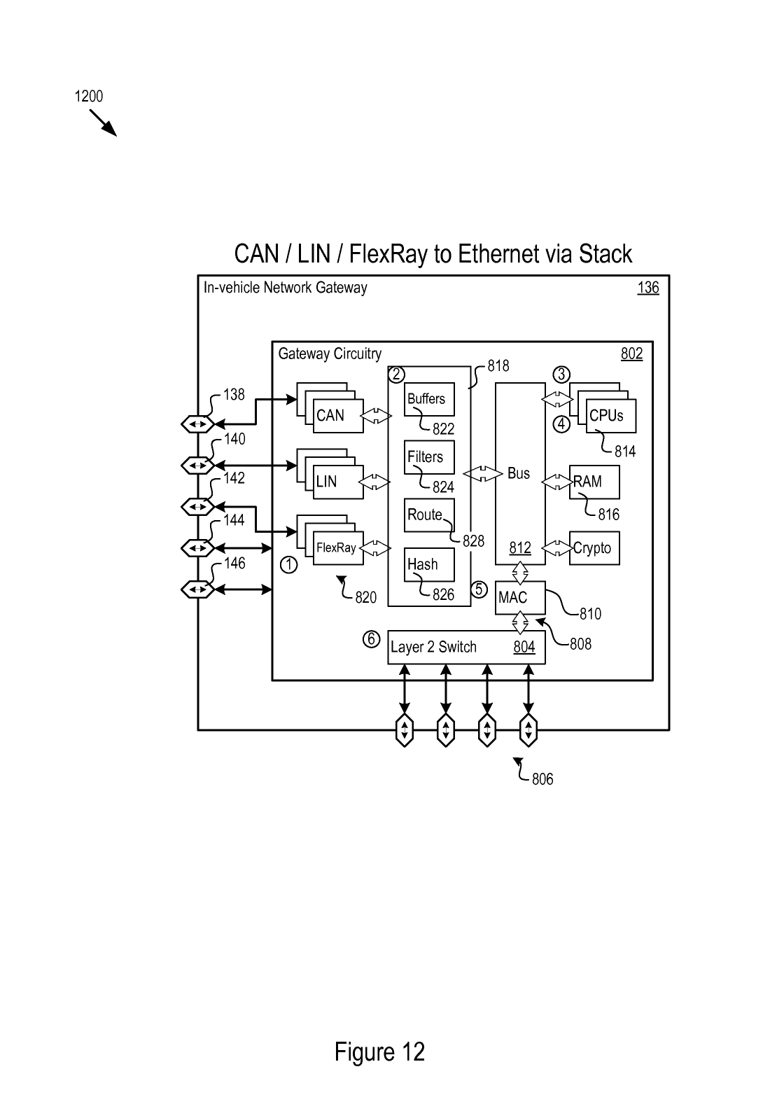

FIG. 12 shows a use case 1200 for CAN/LIN/FlexRay to Ethernet message flow, bypassing hardware acceleration. At (1), a FlexRay message arrives and is stored in a buffer 822. At (2), message filtering occurs, and at (3) the CPU reads the message. At (4), the CPU may execute the software protocol stack 604 to perform initial processing on the message, e.g., to obtain the message identifier and determine that the destination is an Ethernet interface.

In this example, responsive to the configuration settings 606, the CPU determines to bypass hardware acceleration. As a result, the CPU passes the received message back to the software protocol stack 604. The software protocol stack 604 prepares the outgoing Ethernet message and passes the outgoing message to the MAC 810. At (5), the MAC conveys the outgoing message from the system bus 812 to the Ethernet switch 804. The Ethernet switch 804 queues and transmits the outgoing message to the destination port, at (6). A similar message flow from Ethernet to CAN/LIN/FlexRay may occur using the software protocol stack 604 and bypassing the hardware acceleration.

The methods, devices, processing, modules, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

What is claimed is:

1. A gateway comprising:
multiple different communication interfaces comprising:
a protocol A interface;
a protocol B interface;
buffer circuitry coupled to the protocol A interface and configured to receive a message on the protocol A interface, the message comprising:
a message identifier; and
a message payload;
a translation table for a destination network interface, the translation table comprising a mapping from the message identifier to a pre-defined protocol B header for that message identifier; and
control circuitry configured to:
receive the pre-defined protocol B header;
receive the message payload;
prepare a protocol B message comprising the pre-defined protocol B header and the message payload; and
transmit the protocol B message through the protocol B interface.

2. The gateway of claim 1, further comprising:
a message filter configured to pass the message for processing to the control circuitry, when the message meets a filtering criterion.

3. The gateway of claim 1, further comprising:
routing circuitry configured to determine the destination network interface for the message.

4. The gateway of claim 1, where:
the translation table comprises a pointer to the pre-defined protocol B header.

5. The gateway of claim 1, where:
the translation table comprises an index input configured to receive the message identifier for locating the pre-defined protocol B header.

6. The gateway of claim 1, further comprising:
hash circuitry configured to generate an index into the translation table from the message identifier.

7. The gateway of claim 6, where:
the translation table is configured to identify the pre-defined protocol B header in response to the index obtained from the message identifier.

8. The gateway of claim 1, where:
the control circuitry is configured to aggregate the message payload with additional subsequently received message payloads into the protocol B message.

9. The gateway of claim 8, where:
the control circuitry is further configured to aggregate until a transmission criterion is satisfied.

10. The gateway of claim 1, where the control circuitry is further configured to read a configuration setting and selectively bypass a hardware acceleration option as specified by the configuration setting.

11. A method comprising:
in a network gateway:
receiving a message on a protocol A interface, the message comprising a message identifier and a message payload;
determining to perform a translation of the message for transmission through a protocol B interface, where protocol A and protocol B are different communication protocols;
determining whether to apply hardware acceleration to the translation, and when applying the hardware acceleration:
routing the message to determine the protocol B interface for sending the message payload;
performing a lookup in a translation table for the protocol B interface based on the message identifier to identify a pre-defined protocol B header for that message identifier; and
receiving the pre-defined protocol B header;
receiving the message payload;
preparing a protocol B message comprising the pre-defined protocol B header and the message payload; and
transmitting the protocol B message through the protocol B interface.

12. The method of claim 11 where determining to perform a translation comprises:
applying a filter to the message, the filter configured to pass only those messages that meet a filtering criterion.

13. The method of claim 11, further comprising:
when it is determined to not apply the hardware acceleration, submitting the message to a software protocol stack for processing.

14. The method of claim 11, further comprising:
defining a mapping in the translation table from an index to pre-defined protocol B headers.

15. The method of claim 14, where the index comprises the message identifier obtained from the message.

16. The method of claim 14, where the mapping points to a protocol B header pre-defined for the message identifier.

17. The method of claim 11, further comprising:
aggregating the message payload with additional subsequently received message payloads into the protocol B message for increased utilization of the protocol B interface compared to sending individual messages.

18. The method of claim 17, further comprising:
continuing the aggregating until an aggregation timer expires.

19. A system comprising:
multiple different communication interfaces comprising:
a protocol A bus interface;
an Ethernet protocol network interface;
buffer circuitry coupled to the protocol A bus interface and configured to receive messages on the protocol A bus interface, the messages each comprising:
a message identifier; and
a message payload;
a message filter configured to determine:
which of the messages to pass for hardware-accelerated protocol translation;
which of the messages to discard; and
which of the messages to submit to a software protocol stack for handling;
a translation table comprising:
an index input configured to receive an a table index value; and
for each value of the index input, a pointer to a pre-defined Ethernet header;
control circuitry configured to:
receive a particular message passed by the message filter;
obtain a particular Ethernet header for the particular message through the translation table;
generate an Ethernet packet comprising the particular Ethernet header and data payload of the particular message; and
transmit the Ethernet packet through the Ethernet protocol network interface.

20. The system of claim 19, where:
the control circuitry is further configured to aggregate the message payload with additional subsequently received message payloads into the Ethernet packet until an aggregation criterion is reached.
